(19) United States
(12) Patent Application Publication
(10) Pub. No.: US 2007/0174666 A1
(43) Pub. Date: Jul. 26, 2007

(54) Disk device, control circuit, and disk controlling method

(75) Inventor: Takeshi Tanaka, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/411,251

(22) Filed: Apr. 26, 2006

(30) Foreign Application Priority Data
Jan. 18, 2006 (JP) 2006-010477

(51) Int. Cl. G06F 11/00

(52) U.S. Cl. 714/5

(57) ABSTRACT

A timer measures an idling time of a disk. When the idling time is equal to or longer than an idle-time threshold, a head reads each data among a multiplexed data and a comparing unit compares read data with other of the multiplexed data to detect data error in the multiplexed data. A recovering unit recovers data for which the comparing unit detects a data error.

### BACKGROUND OF THE INVENTION

1. Field of the Invention

The present invention generally relates to a technology for multiplexing data and recording the multiplexed data in a disk device. The present invention specifically relates to automatically recovering data error in a disk device.

2. Description of the Related Art

Recently, to improve reliability of data recorded in a magnetic disk device, a method of Redundant Arrays of Inexpensive Disks (RAID) that includes multiplexing data and recording the multiplexed data has been widely used. However, RAID requires a plurality of magnetic disk devices, which leads to increased cost and space occupancy.

One approach is to multiplex data and record the multiplexed data in a single magnetic disk device. Japanese Patent Publication No. 2005-108040, for example, discloses a technology to take backup of desired data from one area in a magnetic disk device to other area in the same magnetic disk device, and read the backup data when a read error occurs during reading of data from the magnetic disk device. The backup is taken when there is no access to the magnetic disk device for some time.

However, in the magnetic disk device described in Japanese Patent Publication No. 2005-108040, it is possible to detect data error only when a read error occurs due to deficit data. In other words, data is read as usual, i.e., without problem, even if the data has a bit error.

### SUMMARY OF THE INVENTION

It is an object of the present invention to at least solve the problems in the conventional technology.

According to an aspect of the present invention, a disk device that records data in a disk medium at a plurality of locations in a multiplexed manner, includes a measuring unit that measures an idling time that is the time for which the disk medium is idle; a reading unit that, when the idling time is equal to or longer than an idle-time threshold, reads each data among a multiplexed data from the disk medium; a comparing unit that compares data read by the reading unit with other of the multiplexed data to detect data error in the multiplexed data; and a recovering unit that recovers data for which the comparing unit detects a data error.

According to another aspect of the present invention, a disk control method of controlling a disk medium that records therein data in at a plurality of locations in a multiplexed manner, includes measuring an idling time that is the time for which the disk medium is idle; reading, when the idling time is equal to or longer than an idle-time threshold, each data among a multiplexed data from the disk medium; comparing data read at the reading with other of the multiplexed data to detect data error in the multiplexed data; and recovering data for which the comparing unit detects a data error.

According to another aspect of the present invention, a control circuit that records data in a disk medium at a plurality of locations in a multiplexed manner, includes a reading unit that, when an idling time of the disk medium is equal to or longer than an idle-time threshold, reads each data among a multiplexed data from the disk medium; a comparing unit that compares data read by the reading unit with other of the multiplexed data to detect data error in the multiplexed data; and a recovering unit that recovers data for which the comparing unit detects a data error.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 depicts a hardware configuration of a magnetic disk device according to an embodiment of the present invention;

FIG. 2 is a detailed functional block diagram of a read/write controller shown in FIG. 1;

FIG. 3 is a schematic for explaining an example of the data structure of a multiplexing controlling table shown in FIG. 2; and

FIG. 4 is a flowchart of a multiplexed data self-recovery process executed by a multiplexing manager shown in FIG. 2.

### DETAILED DESCRIPTION OF THE PREFERRED EMBODIMENTS

Exemplary embodiments of the present invention will be explained below in detail while referring to the accompanying drawings.

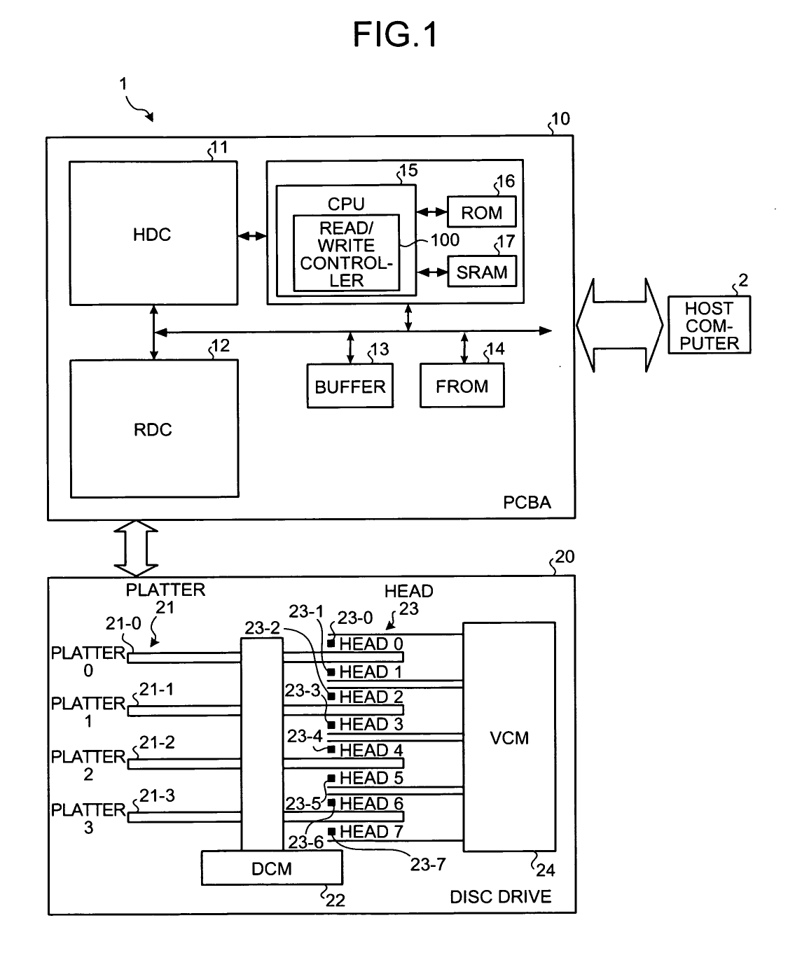

At first, the configuration of a magnetic disk device according to an embodiment of the present invention is explained. FIG. 1 depicts a hardware configuration of a magnetic disk device 1 according to the embodiment. The magnetic disk device 1 includes a printed circuit board assembly (PCBA) 10 and a disk drive 20. The magnetic disk device 1 is connected to a host computer 2 via an ATA interface (not shown). Thus, data, control command, and the like can be exchanged between the magnetic disk device 1 and the host computer 2.

Various LSI's are arranged on the PCBA 10, which is a printed circuit board, and those LSI's are used to control the magnetic disk device 1. The PCBA 10 includes a hard disk controller (HDC) 11, a read channel (RDC) 12, a buffer 13, a fast read-only memory (FROM) 14, a central processing unit (CPU) 15, a read-only memory (ROM) 16, and a static random access memory (SRAM) 17, each of which are mutually connected via a bus.

The HDC 11 is a controller that controls an operation of writing data present in the buffer 13 on the disk drive 20 and an operation of reading the data from the disk drive 20 and storing the same in the buffer 13. The RDC 12 is an LSI that mediates between the buffer 13 and the disk drive 20 to modulate or demodulate data.

The buffer 13 is a cache that temporarily stores the data transacted between the host computer 2 and the disk drive 20. The FROM 14 is a nonvolatile memory that stores the firmware that controls the operation of the magnetic disk device 1. The firmware is read and developed in the SRAM 17 before its execution.

The CPU 15 is a central processor that executes the firmware developed in the SRAM 17. A part of the firmware is executed within the CPU 15 as a read/write controller 100. The read/write controller 100 is a processor that controls reading and writing of data by the magnetic disk device 1, and controls multiplexed read and multiplexed write of the data. Namely, when the host computer 2 specifies multiplexing degree and the like, the read/write controller 100 causes the HDC 11 to execute data write and data read in a plurality of locations of recording data based on the multiplexing degree, and thereby controls the multiplexed read and the multiplexed write of the data.

As described above, the read/write controller 100 orders the HDC 11 to execute data write and data read in a plurality of locations of recording data based on the specification by the host computer 2, and therefore the magnetic disk device 1 can perform multiplexed read or multiplexed write.

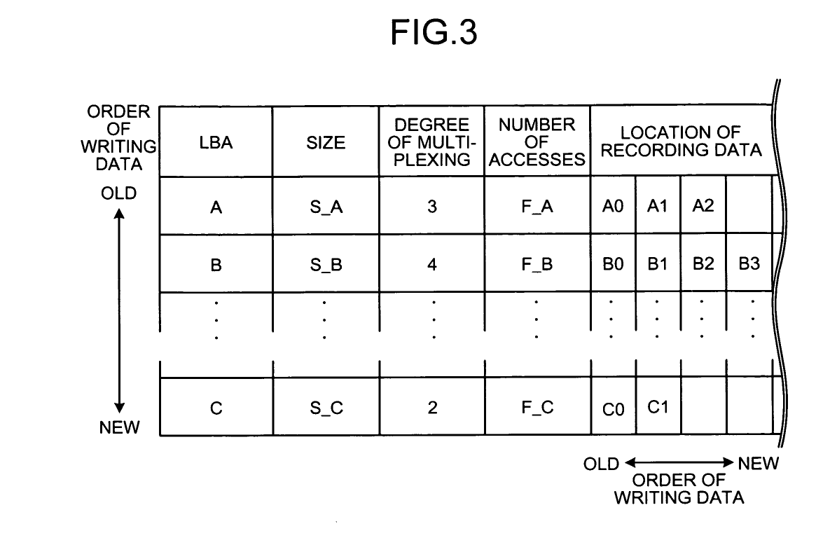

The ROM 16 is a nonvolatile memory that stores therein various parameters required for operating the magnetic disk device 1. The SRAM 17 is a volatile memory used to develop the firmware stored in the FROM 14. The SRAM 17 stores information, such as the locations of the recorded data when the data is multiplexed and recorded, in a multiplexing controlling table 171 (refer to FIG. 3).

The disk drive 20 is a storage unit where data is recorded, and includes four platters 21 (platters 21-0 to 21-3), a direct-current motor (DCM) 22, eight heads 23 (heads 23-0 to 23-7), and a voice-coil motor (VCM) 24.

Each platter 21 is a disk-shaped substrate having two magnetic recording surfaces, i.e., on both top and bottom sides, and also referred to as a magnetic disk medium. The DCM 22 is a driving unit that rotates the platters 21. Each head 23 is a magnetic head that magnetically reads/writes data on a magnetic recording surface of the platter 21. The VCM 24 is a driving unit that moves the head 23 to a desired location of data read/write by moving the head 23 in the radial direction of the disc.

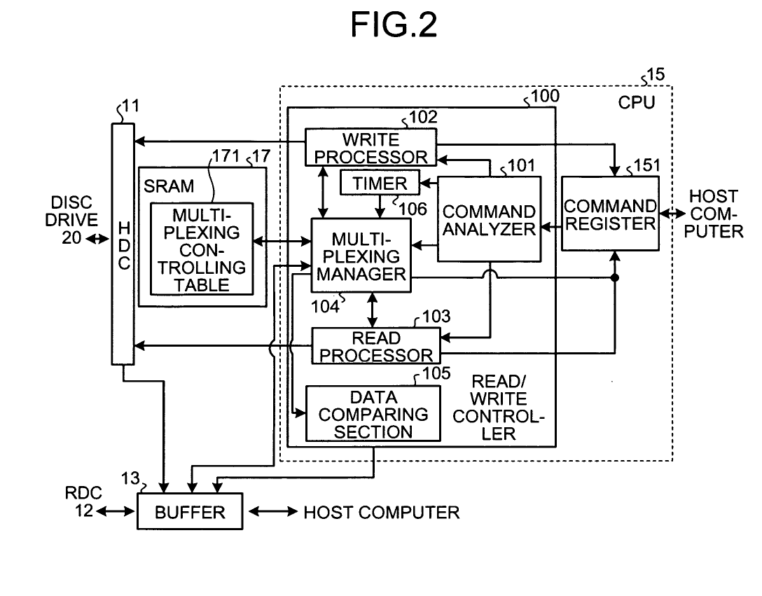

Next, the configuration of the read/write controller 100 is explained. FIG. 2 is a detailed functional block diagram of the read/write controller 100. The CPU 15 includes a command register 151.

The command register 151 is a register that stores therein a control command that the host computer 2, which is an upper level device such as a personal computer or an audio-visual (AV) device, issues to the magnetic disk device 1. The control command may include a command that orders writing of data, a command that orders reading of data, a command that specifies the degree of multiplexing, and the like. The read/write controller 100 includes a command analyzer 101, a write processor 102, a read processor 103, a multiplexing manager 104, a data comparing section 105, and a timer 106. Each control of the multiplexing manager 104 described later is executed by the firmware.

The command analyzer 101 is a processor that analyzes the type of the control command stored in the command register 151, and sorts the control command into the write processor 102 if the control command is a command that orders data write, into the read processor 103 if the control command is a command that orders data read, or into the multiplexing manager 104 if the control command is a command that specifies setup concerning multiplexing of data.

The write processor 102 is a processor that orders the HDC 11 to write data on the disk drive 20. Upon receipt of a write command from the command analyzer 101, the write processor 102 orders the HDC 11 to write data present in the buffer 13 onto a location specified by the multiplexing manager 104.

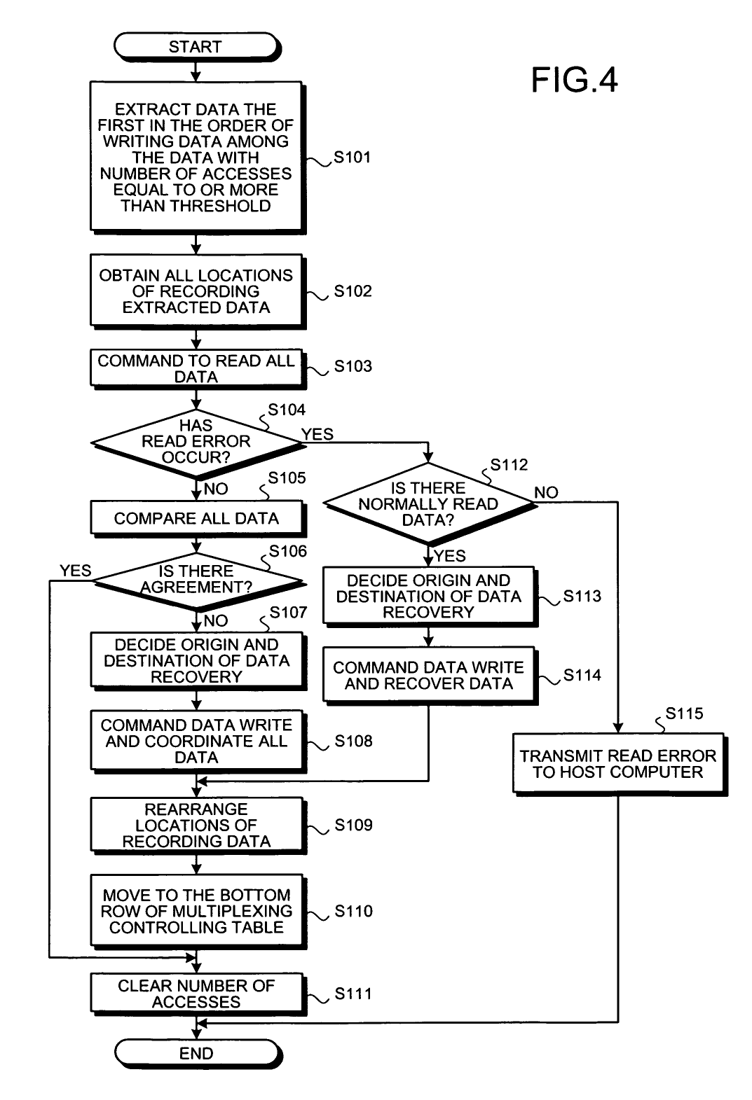

When executing a multiplexed data self-recovery process (refer to FIG. 4), the multiplexing manager 104 specifies to-be-recovered-data and location of recovery, so that the write processor 104 orders the HDC 11 to write the to-be-recovered-data onto the location of recovery thereby recovering the data.

The read processor 103 is a processor that orders the HDC 11 to read data from the disk drive 20. Upon receipt of a read command from the command analyzer 101, the read processor 103 orders the HDC 11 to read the data from the location of data read specified by the multiplexing manager 104 and store the same in the buffer 13.

The multiplexing manager 104 is a processor that manages location of recording multiplexedly written data, number of accesses, and the like, and specifies each location of data read/write when the data is multiplexedly read/written. The multiplexing manager 104 has the data written by deciding a plurality of locations of data write with respect to each data based on the multiplexing specifying command received from the command analyzer 101 and passing the locations of data write to the write processor 102. The multiplexing manager 104 then relates each recording location of the data to information such as the number of time of access to the data and the order of writing when multiplexedly written, and stores the same in the multiplexing controlling table 171.

When there is no access from the host computer 2 to the magnetic disk 1 for certain time, i.e., the idling time of the magnetic disk device 1 is the certain time, the multiplexing manager 104 controls each section of the read/write controller 100 to recover the multiplexed data.

The data comparing section 105 is a processor that, when the read processor 103 stores the multiplexed data in the read buffer 13, executes comparison on all the data to judge whether the data are agreed.

The timer 106 is a timer to measure the idling time of the magnetic disk device 1, and when the idling time is equal to or more than the certain time, the multiplexing manager 104 starts self-recovery of the multiplexed data. The timer 106 always measures the idling time during operation of the magnetic disk device 1, and clears the measured time when the command analyzer 101 receives a control command.

In this way, the timer 106 measures the idling time of the magnetic disk device 1, and when the idling time is equal to or more than a certain time, the multiplexing manager 104 starts self-recovery of the multiplexed data, whereby the magnetic disk device 1 can self-recover the multiplexed data while there is no access.

Next, the multiplexing controlling table 171 managed by the multiplexing manager 104 is explained. FIG. 3 is a schematic for explaining an example of the data structure of the multiplexing controlling table 171. The multiplexing controlling table 171 is recorded in a system area of the disk drive 20 while the magnetic disk device 1 is shut down, and read from the disk drive 20 and stored in the SRAM 17 when the magnetic disk device 1 is boot.

As shown in FIG. 3, the multiplexing controlling table 171 includes a logical block address (LBA) starting to specify host computer, size of the data, degree of multiplexing, number of accesses, and locations where data is present.

The number of accesses is the number of times the host computer 2 accessed the data, and when comparison of the data multiplexed by the data comparing section 105 is executed, the number of accesses is cleared. The multiplexing manager 104 increases the number of accesses by one every time the data under consideration is accessed by the write processor 102 or the read processor 103. When the number of accesses is equal to or more than a threshold, the multiplexing manager 104 regards that the data is frequently accessed, and sets the data as a target of the data comparison executed by the data comparing section 105.

The location is the location where each data is recorded, and the location is specified by the cylinder-head-sector (CHS) format. The order of lateral arrangement of the items in the locations of recording data corresponds to the order of writing the data, indicating that the further to the left the data is located in the figure, the older the final data write time is. For example, for the data having “A” as the LBA, three multiplexed data were written in the order of “A0”, “A1”, and “A2”.

Further, the order of the vertical arrangement in the multiplexing controlling table 171 corresponds to the order of writing the data, indicating that the upper the data is located in the figure, the older the final data write time is. When new data is multiplexed and written, each piece of information of the data is added to the bottom row of the multiplexing controlling table 171. Also, when the multiplexed data is overwritten or recovered, rearrangement of the data is executed in the longitudinal direction according to the order of writing the data, and all the items corresponding to the data are moved to the bottom row of the multiplexing controlling table 171.

When the data comparing section 105 detects disagreement of the data against the multiplexed data, the multiplexing manager 104 coordinates all the data based on the lastly written data among the locations of recording data. For instance, when disagreement of the multiplexed data is detected against the data with LBA of “A”, the multiplexing manager 104 sets “A2” that was written at the last of the three locations of recording data as to-be-recovered-data, and sets “A0” and “A1” that are other locations of recording data as locations of recovery. Based on the decision, the multiplexing manager 104 then controls the write processor 102 to write the data read from the location of recording data “A2” among the read data stored in the buffer 13 on the two locations of recording data, “A0” and “A1”.

When a read error occurs to the multiplexed data at the time the read processor 103 reads the data, the multiplexing manager 104 recovers the data that caused the read error based on the data that was normally read. For example, when a read error occurs to the data to be recorded in “A1” among the data at the LBA “A”, the multiplexing manager 104 sets the data that was read normally (“A0” or “A2”) as the to-be-recovered data, and sets the location of recording data “A1” as a location of recovery. Based on the decision, the multiplexing manager 104 then controls the write processor 102 to write the data written from the location of recording data “A2” among the read data stored in the buffer 13 on the two locations of recording data, “A0” and “A1”. Based on the decision, the multiplexing manager 104 then controls the write processor 102 to write the normally read data among the read data stored in the buffer 13 on the location of recording data “A1”.

As described above, the multiplexing manager 104 manages the multiplexing controlling table 171 having information such as the location of recording data, number of accesses, and order of writing the data with respect to each multiplexed data, and controls execution of data comparison to the data having number of accesses equal to or more than the threshold by the data comparing section 105, whereby it is possible to preferentially compare the data with more access frequency.

Next, a multiplexed data self-recovery process executed by the multiplexing manager 104 is explained. FIG. 4 is a flowchart of the multiplexed data self-recovery process. The multiplexed data self-recovery process is executed when the idling time measured by the timer 106 is exceeds a certain time and continued until receipt of a control command such as the data read from the host computer 2.

To begin with, the multiplexing manager 104 searches the multiplexing controlling table 171, extracts the oldest data in the order of writing among the data having the number of accesses equal to or more than the threshold (step S101), and obtains the locations of the extracted data (step S102).

The multiplexing manager 104 then controls the read processor 103 to read the data at the obtained locations and store the read data in the buffer 13 (step S103), and decides whether a read error has occurred during step S103 (step S104).

If a read error has not occurred, the multiplexing manager 104 controls the data comparing section 105 to execute comparison to all the data stored in the buffer 13 (step S105), and decides whether the data comparing section 105 detected agreement in all the data (step S106).

If there is disagreement of the data, the multiplexing manager 104 coordinates all the data based on the data written at the last of the multiplexed data. Namely, the multiplexing manager 104 sets the data located left most of a plurality of data in the multiplexing controlling table 171 as the to-be-recovered-data and sets other locations of recording data as the locations of recovery (step S107). The multiplexing manager 104 controls the write processor 102 to write the data decided as the to-be-recovered-data into all the locations of recovery to coordinate all the data (step S108).

After that, the multiplexing manager 104 reflects the result of coordinating the data on the multiplexing controlling table 171. Namely, the multiplexing manager 104 rearranges the locations of recording data in the multiplexing controlling table 171 in the lateral direction according to the order in which the data were written at step S108 (step S109), changes the order of multiplexing and writing the data to “latest” by moving all the items corresponding to the coordinated data to the bottom row of the multiplexing controlling table 171 (step S110), and clears the number of accesses (step S111) to terminate the multiplexed data self-recovery process.

On the other hand, if all the data agree, the read/write controller 100 clears only the number of accesses in the multiplexing controlling table 171 without recovering the data (step S111) to terminate the multiplexed data self-recovery process.

When it is determined at step S104 that a read error occurred, the multiplexing manager 104 further decides whether there is any data that was normally read (step S112).

If there is a normally read data, the multiplexing manager 104 recovers the data based on the normally read data. Namely, the multiplexing manager 104 sets one of the normally data as the to-be-recovered-data and sets the location of recording data that caused an error as the locations of recovery (step S113). The multiplexing manager 104 then controls the write processor 102 to write the data normally read and decided as the to-be-recovered-data into all the locations of recovery to recover the data that caused the error (step S114). The multiplexing manager 104 then executes the processings at steps S109 and later to terminate the multiplexed data self-recovery process.

On the other hand, if there is data that was normally read data, i.e., a read error has occurred in all the multiplexed locations of recording data, the multiplexing manager 104 transmits the read error to the host computer 2 (step S115) to terminate the multiplexed data self-recovery process.

In this way, the multiplexing manger 104 causes the data comparing section 105 execute comparison processing to the multiplexed data selected based on the number of accesses and the order of writing data included in the multiplexing controlling table 171, and if these data do not agree, other data are rewritten based on the data written at the last, whereby if is possible to automatically recover the data based on the data written at the last and coordinate all the data to improve reliability of the data.

It has been explained above that the data are coordinated based on the data written at the last of the multiplexed data when the data comparison section 105 detects disagreement of the data; however, when the location of recording data that caused a data error is identified, all the data may be coordinated by rewriting data only in the location of recording data that caused the error. For example, when the degree of multiplexing is three, if only two of three data agree, it is possible to decide that an error has occurred to the only remaining data.

As described above, because the present embodiment is configured so that the timer 106 measures the idling time of the magnetic disk device 1, the data comparing section 105 compares multiplexed data when the idling time is equal to or more than a certain time, and if a data error is detected as a result of the comparison, the multiplexing manager 104 controls the write processor 102 to recover the data that presents the error, it is possible to automatically recover the data error using the time frame when there is no access to the disk to improve reliability of the data.

Moreover, it the present embodiment a magnetic disk device has been explained as an example of a disk device; however, the present invention can be similarly applied to optical disk devices such as a compact disk (CD), a digital versatile disk (DVD), and the like. According to an embodiment of the present invention, it is possible to automatically recover data error thereby improving the reliability of the data.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A disk device that records data in a disk medium at a plurality of locations in a multiplexed manner, the disk device comprising:
a measuring unit that measures an idling time that is the time for which the disk medium is idle;
a reading unit that, when the idling time is equal to or longer than an idle-time threshold, reads each data among a multiplexed data from the disk medium;
a comparing unit that compares data read by the reading unit with other of the multiplexed data to detect data error in the multiplexed data; and
a recovering unit that recovers data for which the comparing unit detects a data error.

2. The disk device according to claim 1, further comprising a counting unit that counts an access number that is number of times each data among the multiplexed data is accessed, wherein
the reading unit reads only data having access number equal to or more than an access number threshold.

3. The disk device according to claim 1, wherein
when the data comparing unit detects disagreement between data, the data recovering unit writes data written last among the multiplexed data at locations of other data among the multiplexed data.

4. The disk device according to claim 1, wherein
when the data comparing unit detects disagreement between data, the data comparing unit identifies data that caused data error among the multiplexed data; and
the data recovering unit writes data on the data that caused the data error thereby recovering the data.

5. The disk device according to claim 1, wherein
when a read error occurs while the reading unit reads certain data among the multiplexed data, the data recovering unit recovering the data that caused the error.

6. A disk control method of controlling a disk medium that records therein data in at a plurality of locations in a multiplexed manner, the disk control method comprising:
measuring an idling time that is the time for which the disk medium is idle;
reading, when the idling time is equal to or longer than an idle-time threshold, each data among a multiplexed data from the disk medium;
comparing data read at the reading with other of the multiplexed data to detect data error in the multiplexed data; and
recovering data for which the comparing unit detects a data error.

7. The disk control method according to claim 6, further comprising counting an access number that is number of times each data among the multiplexed data is accessed, wherein
the reading includes reading only data having access number equal to or more than an access number threshold.

8. The disk control method according to claim 6, wherein
when disagreement is detected between data at the comparing, the recovering includes writing data written last among the multiplexed data at locations of other data among the multiplexed data.

9. The disk control method according to claim 6, wherein
when disagreement is detected between data at the comparing, the disk control method further includes identifying data that caused data error among the multiplexed data, and
the recovering includes writing data on the data that caused the data error thereby recovering the data.

10. The disk control method according to claim 6, wherein
when a read error occurs at the reading when reading certain data among the multiplexed data, the recovering includes recovering the data that caused the error.

11. A control circuit that records data in a disk medium at a plurality of locations in a multiplexed manner, the disk device comprising:
a reading unit that, when an idling time of the disk medium is equal to or longer than an idle-time threshold, reads each data among a multiplexed data from the disk medium;
a comparing unit that compares data read by the reading unit with other of the multiplexed data to detect data error in the multiplexed data; and
a recovering unit that recovers data for which the comparing unit detects a data error.

12. The control circuit according to claim 11, further comprising a counting unit that counts an access number that is number of times each data among the multiplexed data is accessed, wherein
the reading unit reads only data having access number equal to or more than an access number threshold.

13. The control circuit according to claim 11, wherein
when the data comparing unit detects disagreement between data, the data recovering unit writes data written last among the multiplexed data at locations of other data among the multiplexed data.

14. The control circuit according to claim 11, wherein
when the data comparing unit detects disagreement between data, the data comparing unit identifies data that caused data error among the multiplexed data; and
the data recovering unit writes data on the data that caused the data error thereby recovering the data.

15. The control circuit according to claim 11, wherein
when a read error occurs while the reading unit reads certain data among the multiplexed data, the data recovering unit recovering the data that caused the error.

16. The control circuit according to claim 11, further comprising a measuring unit that measures the idling time that is the time for which the disk medium is idle.
